(19) United States
(12) Patent Application Publication
(10) Pub. No.: US 2008/0092806 A1
(43) Pub. Date: Apr. 24, 2008

(54) REMOVING RESIDUES FROM SUBSTRATE PROCESSING COMPONENTS

(75) Inventors: Brian T. West, San Jose, CA (US); Karl Brueckner, Allen, TX (US); Shun Wu, Cupertino, CA (US); Robert Haney, Mountain View, CA (US)

Correspondence Address: JANAH & ASSOCIATES, P.C., 650 DELANCEY STREET, SUITE 106, SAN FRANCISCO, CA, 94107, US

(73) Assignee: Applied Materials, Inc.

(21) Appl. No.: 11/551,114

(22) Filed: Oct. 19, 2006

(51) Int. Cl. B08B 13/00

(52) U.S. Cl. 118/70; 134/1; 427/142

(57) ABSTRACT

Residues are removed from a surface of a substrate processing component which has a polymer coating below the residues. In one version, the component surfaces are contacted with an organic solvent to remove the residues without damaging or removing the polymer coating. The residues can be process residues or adhesive residues. The cleaning process can be conducted as part of a refurbishment process. In another version, the residues are ablated by scanning a laser across the component surface. In yet another version, the residues are vaporized by scanning a plasma cutter across the surface of the component.

### BACKGROUND

Embodiments of the present invention relate to the cleaning of residues from the surfaces of substrate processing components.

The surfaces of substrate processing chamber components which are exposed to a process environment in the processing of substrates, are periodically cleaned between process cycles. During substrate processing, a substrate is placed in the process chamber and exposed to an energized gas to deposit or etch material on the substrate. Process residues which deposit on the component surfaces, include the material being deposited in the CVD or PVD process, etched materials, or even polymeric photoresist removed in etching processes. In subsequent process cycles, the accumulated residues can flake off of the component surfaces and fall upon and contaminate the substrate or chamber interior. Thus, the surfaces of the components are periodically cleaned using cleaning processes that include grit blasting, scrubbing with solvents or abrasives, and carbon dioxide (CO₂) blasting. However, conventional cleaning methods often do not completely clean the component surfaces, result in erosion of component surfaces, or leave behind a thin layer of organic cleaning deposits on the component surfaces.

Cleaning process residues can also have unique problems depending on the compositions of the component surfaces and their overlying residues. For example, some component surfaces are sensitive to conventional cleaning solvents. For example, ceramic components sealed with a polymer sealant, such as electrostatic chucks, silicon carbide components and aluminum chamber walls, are difficult to clean. Organic solvents, such as acetone and isopropyl alcohol, dissolve, oxidize or otherwise chemically react with these coatings. It is particularly difficult to clean the polymer coated surfaces coated with carbon containing polymeric residues, because a cleaning solvent that dissolves the partially polymeric residue can also dissolve the underlying polymer sealant.

It is also difficult to clean process residues comprising carbon deposits or aluminum fluoride from components such as chamber walls. Grit blasting the chamber walls strips not only the carbon residue but also scratches or erodes the surface of the ceramic material. Residues comprising dense aluminum fluoride films that deposit on chamber walls are also particularly difficult to remove because aluminum fluoride is resistant to most chemical strippers. Currently, an HF/HNO₃ mixture is used to etch away aluminum fluoride; however, the acid mixture also often etches away the underlying ceramic material. When the component is coated with a thin anodized aluminum oxide layer, the anodized layer can also be abraded or etched away.

Yet another problem arises when cleaning sticky polymer residue from components used in chemical vapor deposition (CVD), plasma vapor deposition (PVD) and the etch chambers. For dielectric and poly-silicon etch applications, the component has to be heated in a furnace for several hours to burn off organic residue, which is time consuming. For the metal CVD and PVD chambers, current cleaning methods utilize PIRANHA® chemistries (NH₄OH/H₂O₂) for removing process deposits. Such chemistries use toxic and hazardous materials in the cleaning solution. Grit blasting can also be used but can result in removal of at least a portion of a thin layer from the component material or leave behind grit deposits on the components. For dielectric CVD chambers, carbon residues on the ceramic chamber components are first removed by grit blasting, and then overlying AlF₃ deposits are etched away with a HF/HNO₃ mixture, both of which can cause erosion of the underlying component.

Cleaning residues that include adhesives exposed on the component surface during fabrication or recycling are also difficult to clean. For example, electrostatic chucks can be fabricated by gluing a polyimide layer enclosing a sheet electrode to a metal base with an acrylic adhesive. Heaters also have polyimide and other insulating sheets bonded to their surface by adhesives. In fabrication or recycling, when the surface layer of the chuck or heater is removed, adhesive residues that remain on the underlying base need to be stripped off; otherwise, the residues generate burned-off carbon contaminants during substrate processing. Conventional cleaning methods using acetone and wipes often leave behind adhesive or cleaning residues that negatively impact the performance of the refurbished part. While cleaning can be enhanced by use of an abrasive pad, such as Scotch-Brite™, 3M Company, this can also result in erosion of the surface finish of the component.

Yet another problem arises in cleaning residues off textured surfaces of components. For example, in chemical mechanical polishing (CMP) systems, the substrate-retaining ring of metal has a textured surface covered by an epoxy layer and a non-metallic wear resistant layer. To recycle the component, the non-metallic wear resistant layer and epoxy layer have to be machined off, without excessively eroding the underlying metal. However, because the metal has a textured surface, a portion of the textured surface is also typically machined off to get a clean metal surface, thereby reducing the thickness of the metal part and compromising its structural integrity. Cleaning residues off component surfaces that have patterns of laser formed recesses (for example, as disclosed in U.S. Patent Application Publication No. 2003-0188685 to Wang et al., which is incorporated by reference herein in its entirety) is also difficult because the residues collect in the recesses.

Thus, it is desirable to effectively clean-off residues from the surfaces of components without leaving behind other residues generated in the cleaning process. It is further desirable to be able to remove polymeric residues substantially without damaging component surfaces covered with polymer coatings. It is also desirable to clean textured metal or ceramic component surfaces without excessive erosion. It is further desirable to clean-off adhesive residues without damaging or eroding the component. It is also desirable to clean the component surfaces in-situ and without dismantling the chamber.

### DRAWINGS

These features, aspects and advantages of the present invention will become better understood with regard to the following description and appended claims, and accompanying drawings, which illustrate an example of the invention. However, it is to be understood that each of the features can be used in the invention in general, not merely in the context of the particular drawing, and the invention includes any combination of these features, where:

FIG. 1 is a sectional side view of an exemplary embodiment of a substrate processing chamber having component surfaces that can be cleaned by a cleaning process;

FIG. 2 is a sectional side view of a component which is an electrostatic chuck;

FIG. 3 is a sectional side view of an electrostatic chuck with a heater block;

FIG. 4A is a schematic diagram showing laser cleaning of adhesive residues from the textured surface of a component comprising a polymer coated retaining ring for a CMP apparatus;

FIG. 4B is a schematic diagram showing laser cleaning of adhesion residues from a component comprising a gas distribution plate with adhesive residues;

FIG. 5 is a perspective view of a CMP retaining ring;

FIG. 6 is a top view of a gas distribution plate showing a plurality of gas feed holes having different sizes;

FIG. 7A is a schematic top view of a textured surface of a component having parallel trenches and ridges;

FIG. 7B is a sectional perspective view of the textured surface of the component of FIG. 7A;

FIG. 7C is a schematic top view of another embodiment of a textured surface of a component having ridges and depressions;

FIG. 7D is a sectional perspective view of the textured surface of the component shown in FIG. 7B; and

FIG. 8 is a diagram of a plasma cutter apparatus.

### DESCRIPTION

A substrate processing component may be removed from a substrate processing apparatus 302 for cleaning or be cleaned directly in the apparatus 302. The cleaning process has different embodiments, depending on the type of component, and the nature of the residue that remains on the component surface. Each of these cleaning methods can be used separately, or in combination with one another, and accordingly, exemplary illustrations of the cleaning of a particular component with a specific cleaning method, should not be used to limit the present invention to the recited combination. The residue can include, for example, process residues 361 that are formed during processing of a substrate 304—such as etch, CVD, or PVD process residues 361; adhesive or coating residues 361 that remain on the substrate after a stripping or removal process, or other types of residues 361.

In one version, the cleaning method is used to clean surfaces of a substrate processing component coated with a polymer coating, including components such as the internal surfaces of chamber walls 312, exposed surfaces of electrostatic chucks 370, deposition rings or other rings about the substrate 304, and gas distribution plates 600 or nozzles (not shown). The exposed component surfaces are exposed to the energized gas environment used to process a substrate 304 in a chamber 306. The component surfaces are cleaned by contacting the surfaces with an organic solvent or a mixture of solvents that softens and dissolves the residues 361 on the polymer-coated surfaces. For example, the residues 361 being removed from the component surfaces can be process deposits that are formed during previously performed substrate processes conducted in the chamber 306. The organic cleaning solvents used in this method can be one or more of the following compounds: tetrahydrofuran (THF); N-methyl pyrrolidone (NMP); methyl ethyl ketone (MEK); cyclohexanone; toluene; hydroxylamine; ethanol amine; and 2-ethoxy ethanol amine. These solvents can be used independently or as a mixture. The softened or dissolved residues 361 are removed from the substrate processing component surface without removing or excessively dissolving the polymer coating. Further, the adhesive residues 361 are removed with the organic solvent without eroding or otherwise damaging the substrate processing component.

Generally, the residue removal method is advantageous because of the level of residue removal and stripping that can be achieved, especially with residues 361 that are polymeric in nature. A further advantage arises because these solvents are relatively fast acting and it can take only minutes to remove the residues 361 from the internal surfaces of the chamber 306 in-situ. Additionally, the solvents have been found to selectively dissolve the polymeric residues without adversely affecting a polymer coating on the component surface, such as, for example, a polymer sealant comprising methacrylate.

The selected solvents also have specific advantages for different applications. For example, tetrahydrofuran (THF) is particularly advantageous for cleaning residues 361 from component surfaces having chlorinated carbon surfaces. These types of residues 361, for example, can form on the component surfaces when chlorinated gases such as Cl₂ and CCl₄ are used in an etching chamber. The reaction time of the THF with the polymeric residues is relatively short with the THF aggressively reacting with the residues 361. However, the THF is more of a surface reactant rather than a deep penetrating reactant.

As another example, N-methyl pyrrolidone (NMP) is particularly advantageous for cleaning thick residue layers from component surfaces. The thick residue layers can form on the chamber surfaces because of relatively longer usage times or increased process cycles of the process chamber 306. The NMP solvent advantageously penetrates below the surface of the polymer residues partially due to the lower vapor pressure of NMP and removes the residues 361 by the NMP ability to penetrate below the surface of the residues 361. Although NMP is more penetrating than the other solvents of this invention, particularly THF, NMP is not as aggressive in the removal of residues 361 as THF. The organic solvents used in this invention are relatively more effective than acetone in removing the residues 361.

The substrate processing component is sealed by a polymer coating that serves as a sealant. The component can be, for example, an aluminum chamber wall or substrate support 310. The component can also be a composite construction, for example, aluminum that is nickel-plated or anodized; or even a ceramic material, such as aluminum oxide, aluminum nitride or silicon carbide. In one version, the substrate processing component comprises a substrate processing chamber wall 312 that is an aluminum structure coated with (i) nickel plating, (ii) anodized aluminum, (iii) silicon carbide, and (iv) polymer sealant. A suitable polymer sealant that can be applied to the exposed surfaces of the component, comprises methacrylate. For example, one version can be a component comprising an aluminum base with an anodized layer and top layer of methacrylate layer. The methacrylate sealant coating covers the exposed outer portion of the component surface. Preferred formulations of liquid polymerizable materials useful as a polymer sealant according to the invention comprise about 90-99 wt % of a polymerizable monomer or combination of monomers, about 0.1-10 wt % and more preferably about 2-6 wt % of a polymerization initiator, and about 0-10 wt % and more preferably 0.1-4 wt % of an accelerator or combination of accelerators, with all percentages based on the total weight of the non-volatile components of the polymerizable mixture, for example, as described in U.S. Pat. No. 5,792,562 issued to Collins, et al., which is incorporated herein by reference in its entirety. Preferred monomers include the acrylates and dimethacrylates of polyethylene glycol (a product having an average of 9 repeating ethoxy units per polymer), as well as combinations of tetraethylene glycol dimethacrylate and hydroxyethyl methacrylate, for example about 70-90 wt % of tetraethylene glycol dimethacrylate and about 10-30 wt % of hydroxyethyl methacrylate. Preferred accelerator combinations include mixtures of saccharin, N,N-dimethyl-p-toluidene and/or tetrahydroquinoline, for example, about 1-3 wt % of saccharin and about 0.1-1 wt % of N,N-dimethyltoluidene.

Specific sealant formulations that are also suitable for use as a component surface sealant include Loctite 290™ and 990™ adhesive sealants (commercially available from Loctite Corporation, Newington, Conn.), and Perma-Lok HL 126™ (commercially available from Permabond International Corporation, Englewood, N.J.). Additional sealant formulations, which can be employed according to the instant invention, are described in U.S. Pat. No. 5,256,450, issued to Catena, which is also incorporated herein in its entirety by reference.

The component surface can be cleaned by applying a solvent soaked absorbent to the surface of a component, such as an internal surface of a process chamber wall 312, in-situ, without dismantling the chamber 306. Removal of the residues 361 is accomplished by wiping the surfaces of the component chamber wall 312 with the solvent soaked absorbent. The solvent can also be applied several times to the surface with the means of the absorbent until the residues 361 are substantially removed. After the organic solvent has been applied, the surfaces can be further wiped with a clean dry wipe to further remove the residues 361. The application of the solvent with the absorbent softens, dissolves and removes the residues 361.

Suitable absorbents include wipes, applicators, sponges, and towels, which meet clean room requirements. Clean room products are selected for characteristics such as particle emission levels, levels of ionic contaminants, absorptiveness, and resistance to degradation by wear or exposure to cleaning materials. The absorbent, wipe, applicator, sponge, or towel can be selected to avoid microcontamination with respect to the above characteristics. Particles and contaminants, even the smallest particles and contaminants, are frequently many times larger than feature sizes in microelectronic devices. Therefore, an appropriate absorbent can be selected to meet clean room requirements to reduce particle contamination. Suitable absorbents may be made from woven and non-woven materials, such as a meltspun polyolefin substrate, that have properties which meet clean room requirements.

The absorbent, such as a wipe, can also be prepackaged in a substantially airtight pouch with a plurality of wipes. The airtight container prevents the wipe from drying out or attracting dust during handling and storage and to reduce contamination of the wipe. The storage pouch, container or tub for the wipe is also desirably inert to the organic solvent used. In one version, the storage pouch containing the wipes or the wipe itself can be warmed to a temperature slightly above room temperature, to a temperature below the ignition temperature of the solvent to hasten the reaction between the polymer deposition and the organic solvent of the wipe. The prepackaged wipes provide air tight packaging to reduce contamination of the wipes.

In another embodiment, the method uses a spray applicator to contact the residue of the component surface with the organic solvent, followed by wiping the component surface with a contaminate-free absorbent. The spray applicator dispenses the solvent via a nozzle with means of a propellant or pump to spray the organic solvent onto the surface of the component. An absorptive wipe is then used to wipe down the component surfaces to spread the organic solvent and remove the softened or dissolved residues 361. The spray applicator is desirably fabricated from one or more materials that are inert to the organic solvent used to prevent contamination of the organic solvent and the process chamber 306.

In another embodiment, the substrate processing component surface is dipped in the organic solvent in a bath. The bath is contained in a tank, which uses a re-circulating pump, and optionally, a filtration system to remove residues 361 from the bath. The solvent in the tank can also be agitated, for example, by ultrasonic vibrations or energy provided by an ultrasonic vibrator attached to a wall of the tank, for example, the bottom wall. Other stirring methods, including mechanical propeller stirring can also be used to stir the organic solvent in the bath. For very dense or difficult to clean residues 361, the bath method is preferred because it allows the solvent time to chemically react with and remove the residues 361, and also allows the solvent to soak into the fine features of the surfaces of the component. The chamber wall 312 component can be cleaned before or after the substrate 304 has been removed from the chamber 306 or using a combination of methods including occasional cleaning in the chamber 306 itself with wipes or solvent spray, and occasional cleaning in a bath to remove hard to clean residues 361.

Furthermore, the component surfaces can be contacted with an organic solvent and residues 361 are removed with the organic solvent without removing or adversely affecting sensitive coatings like polymer and ceramic coatings. In addition, the organic solvents dissolve, react, and/or soften the residues 361 in a relatively fast manner. For example, residues 361 can be removed from polymer coatings such as a polymer sealant, such as for example, methacrylate and the organic solvent can be tetrahydrofuran (THF), N-methyl pyrrolidone (NMP), methylethyl ketone (MEK), cyclohexanone, toluene, hydroxylamine, ethanol amine, 2-ethoxy 2-ethanol amine, or mixtures thereof. The organic solvent can be applied with an absorbent substrate, a spray applicator or a combination of both an absorbent substrate and spray applicator. The component surfaces can be contacted with the organic solvent more than once or singularly contacted with the organic solvent. Furthermore, the method may be used as a stand-alone method or in conjunction with other prior art method as a pre-process step or steps.

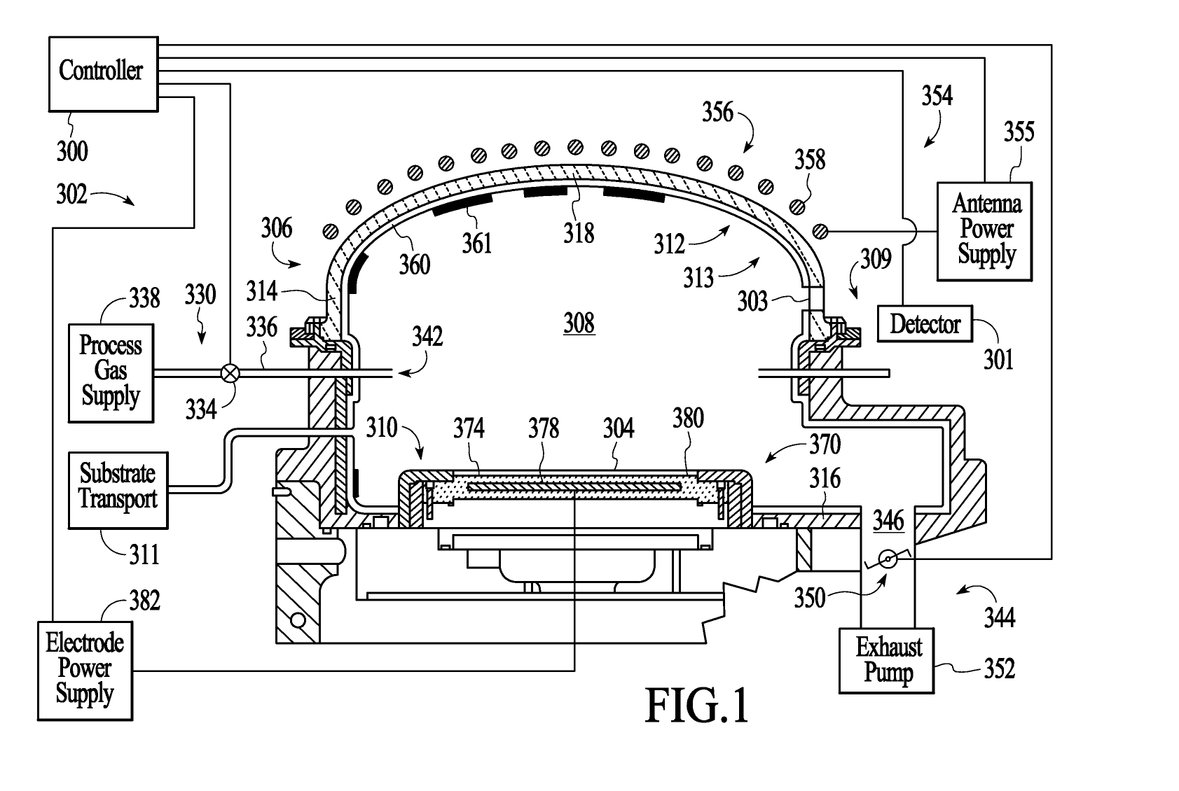

The aforementioned cleaning processes can be used to clean any of the components of a substrate processing apparatus 302, an exemplary version of which is schematically illustrated in FIG. 1, which is suitable for etching substrates 304 such as semiconductor wafers. The apparatus 302 includes components such as a process chamber 306 that is operated by controller 300. The chamber 306 comprises further components such as the walls 312 which are typically made of metal or ceramic materials, including sidewalls 314, bottom wall 316, and a ceiling 318 that can be cleaned to remove residues 361 361 generated during processing of the substrate 304 without removing the polymer sealant 360. In operation, a gas supply 338 provides process gas to the chamber 306. The gas supply 338 is connected to a gas conduit 336 having one or more flow control valves 334. The conduit 336 terminates in one or more gas inlets 342 in the chamber 306. Spent process gas and etchant byproducts are exhausted through an exhaust 344 which includes a pumping channel 346 that receives spent process gas, a throttle valve 350 to control the pressure of process gas in the chamber 306, and one or more exhaust pumps 352. The exhaust 344 may also contain an abatement system (not shown) for abating undesirable gases from the exhaust.

The process gas provided in the chamber 306 is energized to process the substrate 304 by another chamber component that is a gas energizer 354 that couples energy to the process gas in the process zone 308 of the chamber 306 (as shown) or in a remote zone upstream from the chamber 306 (not shown). In one version, the gas energizer 354 comprises an antenna 356 comprising one or more inductor coils 358 which may have a circular symmetry about the center of the chamber 306. When the antenna 356 is positioned near the ceiling 318 of the chamber 306, the adjacent portion of the ceiling may be made from a dielectric material, such as silicon dioxide, which is transparent to RF or electromagnetic fields. An antenna power supply 355 provides, for example, RF power to the antenna 356 at a frequency of typically about 50 KHz to about 60 MHz, and more typically about 13.56 MHz; and at a power level of from about 100 to about 5000 Watts. An RF match network (not shown) may also be provided. Alternatively or additionally, the gas energizer 354 may comprise a microwave or an “up-stream” gas activator (not shown).

In one version, the gas energizer 354 may also or alternatively comprise additional process components such as electrodes 313, 378 that may be used to energize the process gas. Typically, the process electrodes 313, 378 include one electrode 313 in a sidewall 314 or ceiling 318 of the chamber 306 that is capacitively coupled to another electrode, such as an electrode 378 in the support 310 below the substrate 304. When the ceiling component 318 also serves as an electrode, the ceiling 318 may comprise a dielectric material that serves as an induction field-transmitting window 303 that provides low impedance to an RF induction field transmitted by the antenna 356 above the ceiling 318. Suitable dielectric materials that can be employed include materials such as aluminum oxide or silicon dioxide. Generally, the process electrodes 313, 378 may be electrically biased relative to one another by an electrode voltage supply (not shown) that includes an AC voltage supply for providing an RF bias voltage. The RF bias voltage may comprise frequencies of about 50 kHz to about 60 MHz, and the power level of the RF bias current is typically from about 50 to about 3000 Watts.

In operation, another chamber component that is a substrate transport 311, such as, for example, a robotic arm (not shown), transports a substrate 304 onto the substrate support 310 in the chamber 306. The substrate 304 is typically received on lift pin components (not shown) that extend out of the substrate support 310 to receive the substrate 304 and retract back into the substrate support 310 to deposit the substrate 304 on the support 310. The substrate support 310 may comprise an electrostatic chuck 370 which comprises a dielectric body 374 which at least partially covers the electrode 378 and which may include a substrate receiving surface 380. The electrode 378 may also serve as one of the process electrodes discussed above. The electrode 378 may be capable of generating an electrostatic charge for electrostatically holding the substrate 304 to the support 310 or electrostatic chuck 370. A power supply 382 provides the electrostatic chucking voltage to the electrode 378.

The apparatus 302 further comprises one or more detector components 309 that are adapted to detect the intensities of one or more wavelengths of the radiation emission and generate one or more signals in relation to the detected intensities. A suitable detector 309 comprises a sensor 301, such as, for example, a photomultiplier tube, spectrometer, charge coupled device or photodiode. The detector 309 is typically positioned to detect radiation passing through a window 303 formed in a wall 312 of the chamber 306 that is permeable to radiation of the desired wavelengths. The detector 309 detects intensities of wavelengths of radiation emission to control chamber treatment or processing conditions.

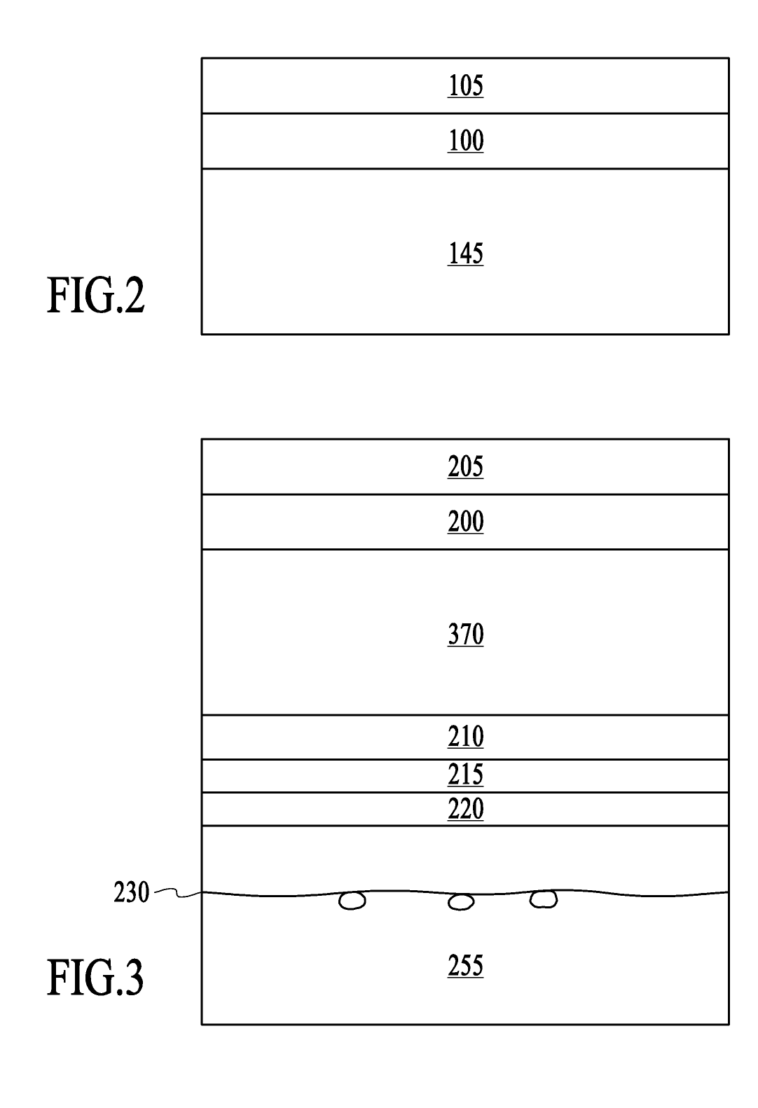

In another version of a cleaning process, a surface of a substrate processing component that is removed from a chamber 306 is cleaned of residues 361 361, and optionally refurbished after the cleaning process. For example, the component to be cleaned and refurbished can be an electrostatic chuck 370. As shown in FIG. 2, the electrostatic chuck 370 can comprise an upper layer 105 that is bonded to a metal body (not shown) with an adhesive, such as an acrylic adhesive. The layer 105 can be a partially conductive, conductive, or insulative polyamide; or a partially conductive, conductive, or insulative tape available from Chomeric™ that is removed from the chuck 370 by a physical process such as peeling of the polymer layer from the chuck 370. The layer 105 contains an embedded electrode (not shown) that may be chargeable to generate an electrostatic charge to hold a substrate 304 to the chuck 370. The bonding adhesive 100 can also be softened by contacting with an organic solvent prior to removing the layer 105. The organic solvent suitable for use to clean the adhesive 100 is tetrahydrofuran (THF), methyl ethyl ketone (MEK), heptane, ethyl acetate, N-methyl pyrrolidone (NMP), cyclohexanone, toluene, hydroxylamine, ethanol amine, 2-ethoxy ethanol amine or mixtures thereof. The adhesive 100 is contacted with the organic solvent and removed with wiping or rinsing the adhesive 100 without adversely affecting the ceramic electrostatic chuck 370.

A particular substrate processing component that is often cleaned and refurbished, is an electrostatic chuck 370 mounted on a heater block 255 with an embedded heater coil 230, an example of which is schematically shown in FIG. 3. The electrostatic chuck 370 is a ceramic structure and is bonded to an upper layer or sheet 205 with an adhesive 200, and is bonded to layer 215 with adhesive 210. The adhesive 220, layer 215, and adhesive 210 can be a conductive tape with adhesive available from Chomeric. Also, layer 205 and adhesive 200 can be a conductive tape with adhesive also available from Chomeric™. The lower polymer layer 215 is also bonded to heater block 255 with adhesive 220. The adhesive 200 can be an acrylic adhesive and the heater block 255 is a metal structure. The layers 205 and 215 can be made from polyamide, and in some versions, includes an embedded copper electrode (not shown). The upper layer 205 is removed by a physical process such as peeling of the sheet from the ceramic electrostatic chuck 370 wherein the adhesive 200 can be softened by contacting with an organic solvent prior to removing the polymer layer 205. The organic solvent used to clean the adhesives 200, 210, and 220 is tetrahydrofuran (THF), methylethyl ketone (MEK), heptane, ethyl acetate, N-methyl pyrrolidone (NMP), cyclohexanone, toluene, hydroxylamine, ethanol amine, 2-ethoxy 2-ethanol amine or mixtures thereof. The electrostatic chuck 370 and heater block 255 can be contacted with an organic solvent to soften the adhesive prior to separating the lower layer 215, the electrostatic chuck 370 and heater block 255. After the upper layer 205 is removed and the electrostatic chuck 370, heater block 255 and lower layer 215 are separated, the adhesives 200, 210 and 220 are contacted with the organic solvent and removed with wiping or rinsing the adhesives 200, 210 and 220 without adversely affecting the ceramic electrostatic chuck 370 and the heater block 255. In one version, the polymer layer on the ceramic structure is replaced.

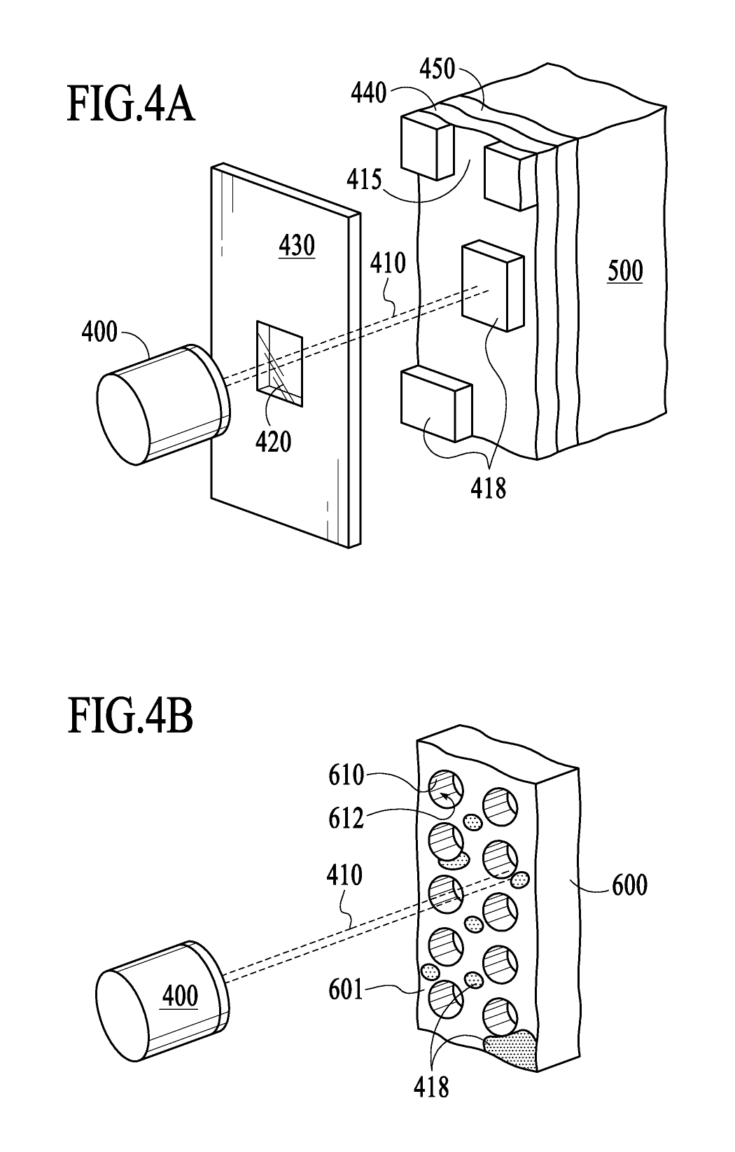

Yet another version of the cleaning process is used to clean residues 361, such as for example residual adhesives, off the surface of a substrate processing component during, for example, refurbishment of the component. In this version, a laser 400 provides a laser beam 410 in the form of a pulsed or continuous wave beam, with proper wavelength and adequate energy density that is scanned across a component surface 415 to strip and burn-off or ablate residual adhesives 418, as for example shown in FIG. 4A. The laser beam 410 may be applied to the component surface 415 after removing the component from the substrate processing apparatus 302. The laser beam 410 may be applied to the component surface 415 through a window 420 of a laser beam treatment chamber 430 into which the component is placed, the window 420 being made of light-transmitting, chemical resistant materials. The laser 400 may also be located inside the laser chamber 430 (not shown). Carrier gases can also be used by being flown across the surface of a substrate processing component to carry the gaseous or vaporized adhesive deposits that were removed to downstream areas of the laser chamber.

Suitable lasers 400 comprise a CO₂ laser, Nd—YAG laser (neodymium yttrium aluminum garnet), Er:Nd—YAG laser (erbium ND—YAG), argon laser, high power diode laser, and other solid state lasers. Argon lasers have wavelengths of 488 nm or 514 nm, diode lasers provide 810 to 980 nm, ND/YAG lasers generate wavelengths of typically 1064 nm, Er:Nd—YAG lasers provide 2940 nm, and CO₂ lasers provide 9300 to 10600 nm. While some illustrate wavelength ranges and valves are provided, it is known that these can be modified to other wavelength ranges.

The laser power density is regulated to (i) defragment and vaporize the residues 361, such as the adhesive or polymeric residues without damaging to the underlying structure of the component, (ii) remove both the adhesive residues and the epoxy layer, and/or (iii) scribe features into the underlying structure. A well-controlled dynamic focusing beam is desirable to focus and scan the entire surface contour of the component having the residues 361. Multiple beam configurations may be necessary to achieve the highest cleaning efficiency. Suitable lasers 400 provide a power density of, for example, from 9.6×10⁶ W/cm² to 8.6×10⁷ W/cm² for a laser having a power level in the range of about 100 to about 5000 Watts. The density for the 5 kW laser is not likely to be greater but is likely to have a wider beam. Another important laser parameter is pulse frequency, with the power of each pulse increasing as its frequency decreases. For example, to remove polymer surface coatings, a pulse frequency of 10 to 90 kHz, and more typically about 30 KHz can be used. For surface texturing with a laser 400, suitable pulse frequencies include those from about 4 to about 36 kHz, and more typically about 12 kHz.

In one version, a substrate processing component comprising a surface comprising adhesive residues 361 over a polymer layer which is on an underlying metal structure, is refurbished. The adhesive residues 361 comprise an acrylic adhesive residue. The polymer layer comprises an epoxy layer. A laser beam is scanned across the surface of the substrate processing component at an energy density level that is sufficiently high to ablate the adhesive residues 361 and the epoxy layer as well as scribe the surface of the metal structure with ablation lines in addition to ablating the adhesive residues 361 and epoxy layer. Then, optionally, a new polymer layer is formed on the metal structure.

In one example, as shown in FIG. 4A, a Nd—YAG laser 400 generates a laser beam 410 that ablates and vaporizes adhesive residues 418 that are on a component surface 415, such as on the surface of an epoxy coat 440 over a Lavacoat™ layer 450 on a substrate processing component comprising a retaining ring 500 from a chemical mechanical polishing (CMP) apparatus. Advantageously, the laser beam 410 can clean both the adhesive residues 361 off from the surface 415 as well as ablate off the epoxy coat 440, and even clean-out the depressions and features of the Lavacoat™ layer 450. The retaining ring 500 is used in a CMP apparatus, such as one available from Applied Materials, Santa Clara, Calif., for planarization of a substrate 304 mounted on a substrate carrier which faces a polishing head with a polishing pad. A CMP apparatus is described in U.S. Pat. No. 5,738,574, and a carrier head is described in U.S. Pat. No. 6,251,215, both of which are incorporated herein by reference in their entireties.

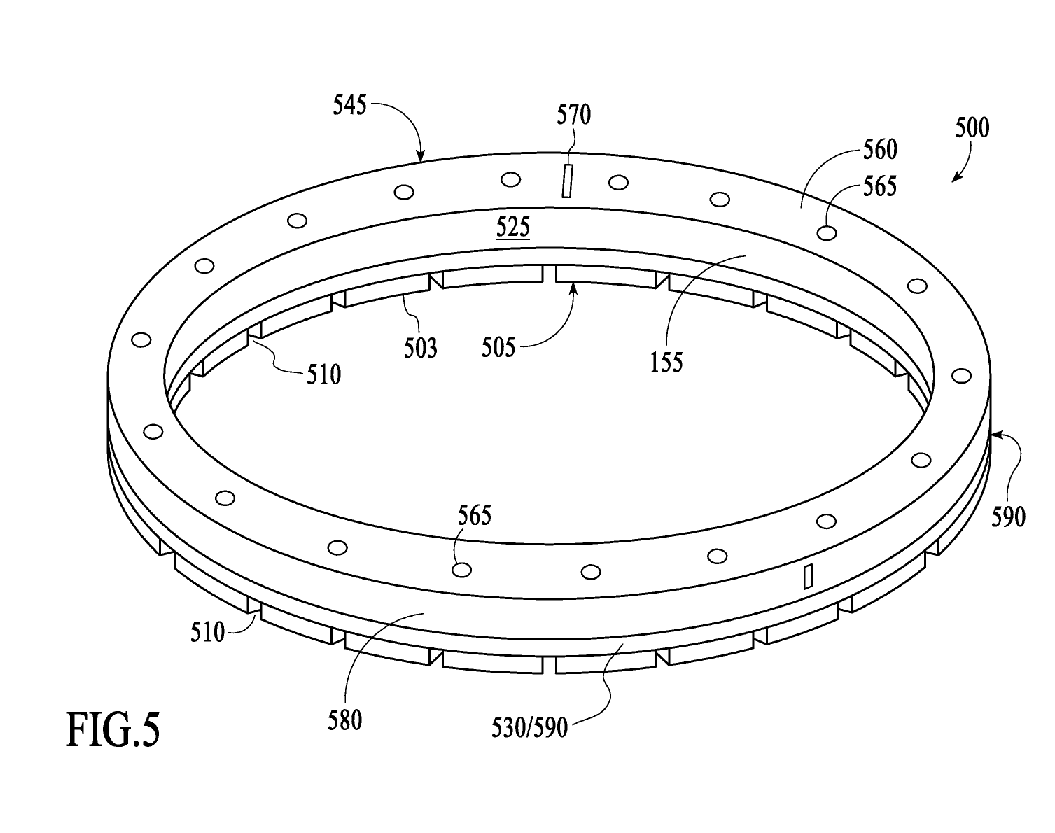

FIG. 5 shows a retaining ring 500 having a first lower portion 505 with a flat bottom surface 503, which includes channels 510, or grooves, a sloping portion 530/590, and vertical portion 525. The straight channels 510 begin at the inner circumference and end at the outer circumference of the bottom surface and can be distributed at equal angular intervals around the retaining ring 500. The channels 510 are typically oriented at 45° relative to a radial segment extending through the center of the retaining ring 500, but other angles of orientation, such as between 30 and 60°, are also possible. The lower portion 505 of the retaining ring 500 can be formed from a material that is chemically inert to the CMP process and that is sufficiently elastic that contact of the substrate edge against the retaining ring 500 does not cause the substrate 304 to chip or crack.

The second piece of the retaining ring 500, the upper portion 545, has a flat bottom surface and a vertical section 580 and a top surface 560 that is parallel to the bottom surface. The top surface 560 includes holes 565 to receive bolts, screws, or other hardware for securing the retaining ring 500 and carrier head together. Additionally, one or more alignment apertures 570 can be located in the upper portion 545. If the retaining ring 500 has an alignment aperture 570, the carrier head can have a corresponding pin (not shown) which mates with the alignment aperture 570 when the carrier head and retaining ring 500 are properly aligned. The upper portion 545 can be formed from a rigid material, such as metal. Suitable metals for forming the upper portion include stainless steel, molybdenum, or aluminum, or a ceramic can be used. The lower portion 505 and the upper portion 545 can be joined using an adhesive, screws, or a press-fit configuration. The adhesive layer can be a two-part slow-curing epoxy, such as Magnobond-6375 available from Magnolia Plastics of Chamblee, Ga.

FIG. 4B shows a portion of a component comprising a gas distribution plate 600 used in a processing chamber 306, which can be cleaned by laser ablation using the laser 400. The laser beam 410 is capable of ablating and vaporizing adhesive residues 361 418 that are left behind on the exposed surface of the plate 600. In this version, an aluminum layer is removed from the plate 600, leaving behind the adhesive residues 361 418 on the exposed surface 601 of the plate 600. The plate 600 has a number of holes 610 through which a gas is passed during use of the component in a process chamber. The residues 361 can stick to the surface of the plate 600 as well as the internal surfaces 612 of the holes 610. Laser ablation is used to clean both the exposed surface 601 of the plate 600 and the internal surfaces 612 of the holes 610 by simply traversing the laser 400 at a fixed speed across the plate 600. A suitable laser can be operated at a power of from about 100 Watts to about 5000 Watts.

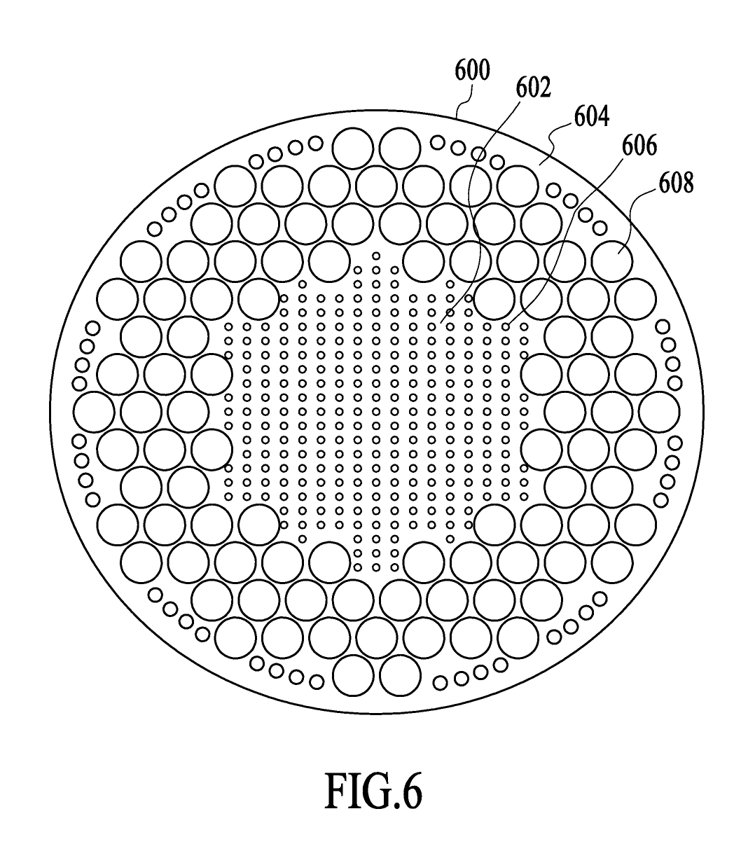

FIG. 6 shows another embodiment of the gas distribution plate 600 with a thinner central portion 602 having fewer and smaller apertures 606 and a thicker circumferential portion 604 having more and larger apertures 608. The gas distribution plate 600 has sufficiently low mass to permit rapid heating to an equilibrium temperature, as determined by radiated heat loss, and provides even gas distribution over the surface of a substrate 304. The central portion of the gas distribution plate 600 may have smaller holes 606 that compensate for center fast process gas flow, where the holes increase in number and size approaching the thicker circumference 604 of the gas distribution plate 600 to increase the flow of process gas at the wafer's edge. The actual arrangement of apertures is considered to be a matter of choice and may be arrived at independently of the section profiled imparted to the gas distribution plate 600. The different sized holes on the gas distribution plate 600 make laser ablation particularly suitable for cleaning the exposed surfaces of the gas distribution plate 600 and the internal surfaces of the different sized holes, since the laser can traverse more easily across the exposed surfaces and different sized holes while still providing the same ablative energy for the residue ablation process.

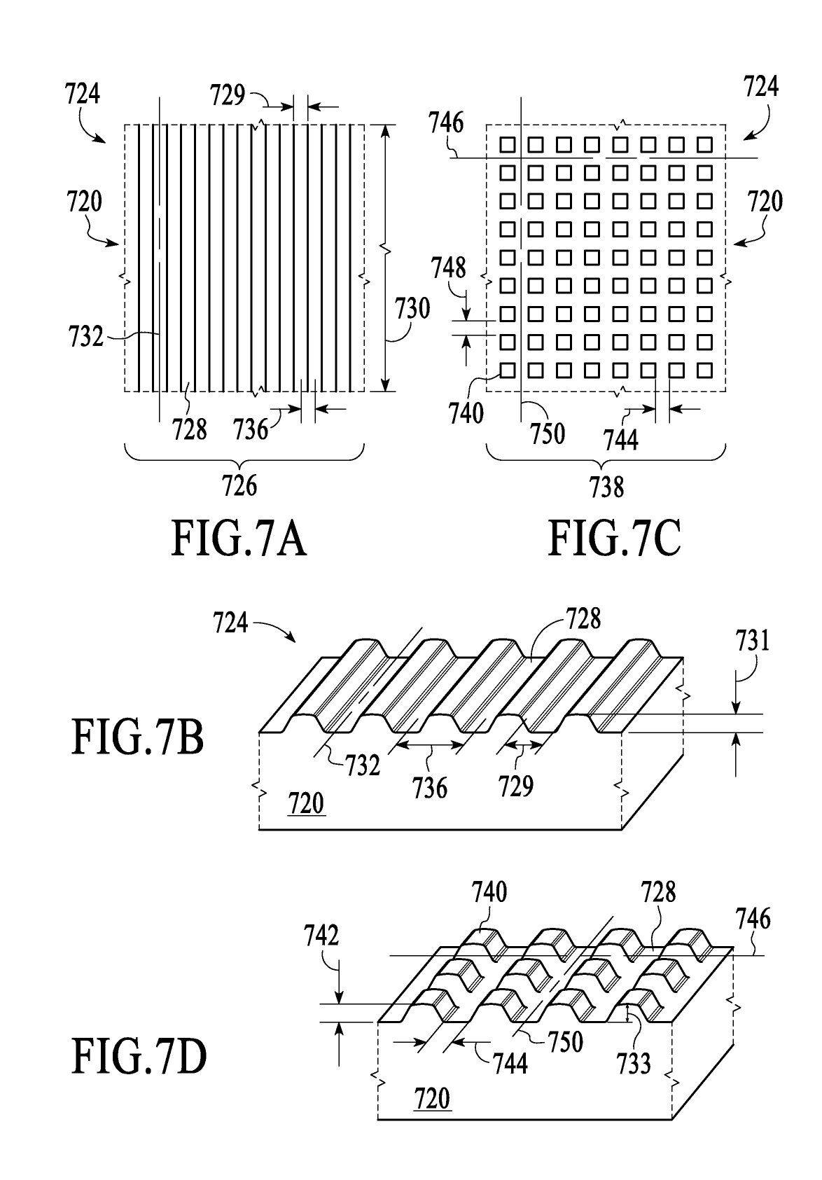

After laser ablation of residual adhesives, the components can also be further ablated by the laser beam 410 to scribe features into the surface to produce a laser-textured surface. For example, FIG. 7A illustrates a schematic top view of the laser-textured surface 724 of a substrate processing component 720 and FIG. 7B illustrates a sectional perspective view of the same laser-textured surface 724. The substrate processing component 720 has a body comprising a metal, such as aluminum, copper, stainless steel, tantalum, and titanium; a ceramic, such as aluminum oxide, quartz, silicon nitride and titanium oxide; or a polymer, such as polyimide, composite plastic or PEEK. The component 720 may also comprise a combination of these materials, such as a polymer coating on an aluminum oxide or metal component. As another example, the component 720 may have a body comprising a first material that is a metal, such as titanium, and a coating comprising a second material that is a ceramic, such as titanium oxide.

The laser-textured surface 724 of the component 720 provides improved adhesion of residues 361 formed on the component 720 in the processing chamber 306. The laser-textured surface 724 of the component 720 may be any surface of the component 720. For example, the laser-textured surface 724 of the component 720 may be a surface of the component 720 that is exposed to a gas or plasma in the substrate processing chamber 306 that typically produces a process residue, which deposits on the component surface. The laser-textured surface 724 presents surface features to the internal environment of the processing chamber 306 on which residues 361 can collect and adhere and still remain firmly attached even after a sizable amount of residues 361 are deposited in the textured surfaces in multiple substrate processing cycles. By firmly adhering to the laser-textured surface 724, the residues 361 are substantially prevented from flaking off the component 720 and contaminating substrates 304 being processed in the chamber 306. The improved adhesion of residues 361 allows longer periods of continuous chamber use before the components 720 need to be cleaned to remove residues 361 that may flake or peel off the component 720.

In one version of laser texturing, as illustrated in FIGS. 7A and 7B, the laser-textured surface 724 comprises an array 726 of periodically spaced-apart grooves 728. Each individual groove 728 within the array 726 has a width 729, length 730 and depth 731, as well as a longitudinal axis 732 that runs along the length 730. The groove 728 can be fabricated to have particular ratios of length 730 to width 729, or depth 733 to width 729, depending on the types of residues 361, which are sought to adhere to the grooves to improve adhesion and retention of residues 361 to the laser-textured surface 724. For example, grooves 728 that are long and narrow with a high ratio of length to width provide good adhesion of soft residues 361 because such grooves 728 provide a relatively high surface area that grip the soft residues 361 better. Also, the narrow, less deep grooves 728 are easier to clean to remove the soft residues 361. These grooves 728 are good for soft polymeric etch residues 361 that are formed in etching processes conducted in etching process chambers. In one version, the groove 728 has a ratio of length 730 to width 729 of greater than about 40:1 and more preferably greater than about 80:1. For example, such narrow grooves 728 can have dimensions that include a depth of 0.1 mm to 2 mm, and more typically a depth of 0.25 mm; a width also of 0.1 mm to 2 mm, and more typically 0.25 mm; and a length of at least about 20 mm. The grooves 728 can also form a single spiral that extends from the edge of the surface to the center of the chamber component, and can also be formed as concentric arcs or parallel, concentric circles.

Wide grooves 728 that have smaller length to width ratios can be advantageous for the adhesion of residues 361 such as aluminum or copper deposits formed in PVD processes, because these softer metal materials are less likely to fracture and flake off than brittle materials for a given depth of the groove. Also, the relatively wider groove 728 allows the softer material to flow or reflow into and along the groove 728, reducing accumulation of residues 361 on the surfaces of the adjacent ridges. For example, the grooves 728 can serve as reservoirs to contain the aluminum reflow residue material. In one version, such grooves 728 can have ratios of length 730 to width 729 of less than about 30:1. For example, these grooves 728 can have dimensions that include a depth of 1 mm to 5 mm and a width of 1 mm to 10 mm.

Harder or more brittle residues 361 typically better adhere to grooves 728 that have a relatively low occurrence rate of sharp changes in the geometry of the laser-textured surface 724. A high surface area of the laser-textured surface 724 provides a larger area on which the residues 361 may collect and adhere, thus increasing the effectiveness of the laser-textured surface 724 to collect and retain residues 361. However, frequent sharp changes in surface geometry caused by the large number of grooves 728, may generate localized instances of increased mechanical stress within deposited residues 361, especially when the residues 361 are brittle. These localized instances of increased mechanical stress may reduce adhesion of residues 361 by inducing stress-related flaking and peeling of the residues 361. Thus, a relatively low occurrence rate of sharp changes in the geometry of the laser-textured surface 724 also increases the effectiveness of the laser-textured surface 724 to collect and retain hard residues. Typical brittle residues include ceramic and refractory metals, such as tantalum, titanium, tantalum nitride, and titanium nitride. These more brittle materials are typically better adhered with grooves having ratios of length 730 to width 729 of less than about 40:1, for example, from 10:1 to 30:1, and fewer sharp corners and edges in the surface geometry of the laser-textured surface 724.

The array 726 of periodically spaced-apart grooves 728 can also has a characteristic separation distance 736 between the centers of adjacent grooves 728. The separation distance is the period over which physical features of the array 726 repeat. For example, the cross-sectional profile of the groove 728 may include a rounded corner that repeats periodically over the array 726 of grooves 728. The separation distance 736 is selected to optimize the adhesion of residues 361 to the laser-textured surface 724. For example, in one version, the separation distance 736 is selected to optimize the surface area of the laser-textured surface 724 exposed to the environment of the processing chamber to increase the collection and retention of residues 361 to the laser-textured surface 724. The separation distance 736 can be selected to be sufficiently small such that the grooves 728 are relatively densely spaced across the exposed surface, thereby increasing the surface area, and sufficiently large so that adjacent grooves 728 do not overlap and decrease the surface area. The separation distance 736 may also be related to the laser texturing process used to form the array 726 of grooves 728. For example, in one version, the separation distance 736 is selected to be a function of the wavelength of the laser used to produce the laser-textured surface 724, such as from about 0.5 ë to about 5.0 ë, where ë is the wavelength of the laser used to form the laser-textured surface 724. This version of the separation distance 736 is advantageous because it is a convenient range of separation distances 736 to operate a laser apparatus 400 and also produces an optimized surface area of the laser-textured surface 724.

In one version, the surface of the component 720, which is exposed to the internal environment of the processing chamber 306, may be substantially entirely covered by the array 726 of periodically spaced-apart grooves 728. The array 726 of periodically spaced-apart grooves 728 can also be provided to align with geometrical features or curvatures of components 720 having the laser-textured surface 724. For example, a component 720 may have a substantially circular geometry, or some other geometry, and the array 726 of spaced-apart grooves 728 may be aligned such that the longitudinal axes 732 of the grooves 728 follow the curvature of the component 720. This increases the effectiveness of the laser-textured surface 724 to collect and retain residues 361. For example, the grooves 728 having longitudinal axes 732 that follow the curvature of the component 720 are generally able to have relatively larger length to width ratios. In contrast, grooves 728 having longitudinal axes 732, which do not follow the curvature of the component 720, may encounter a border or transition region on the component surface that requires the groove 728 to end prematurely. Grooves 728 having longitudinal axes 732 that follow the curvature of the component 720 may also increase the ease with which the laser-textured surface 724 may be fabricated on the component 720. For example, it may be easier for a laser apparatus 400 to follow an inherent geometry of the component 720 rather than run counter to the geometry. In contrast, to fabricate the array 726 of grooves 728 of the laser-textured surface 724 having longitudinal axes 732 against the curvature of the component 720 may require relatively more complex positioning equipment to create the grooves 728.

In another version, the laser-textured surface 724 comprises an array 738 of grooves 728 formed by periodically spaced-apart knobs 740, as illustrated in FIGS. 7C and 7D. The array 738 of periodically spaced-apart knobs 740 comprise a two-dimensional array having elements aligned in a grid having two orthogonal axes. The knobs 740 can be square or rounded projections having a characteristic cross-section that extend out from the surface of the component 720. In one version, the knobs 740 have a square cross-section with tapered sidewalls. The array 738 of knobs 740 have a characteristic separation distance between the centers of adjacent individual knobs 740, including a first separation distance 744 along a first axis 746 of the array 738 and a second separation distance 748 along a second axis 750 of the array 738. The first and second axes 746, 750 of the array 738 are perpendicular to each other and are oriented in directions along which the knobs 740 substantially align and repeat. In one version, the first and second separation distances 744, 748 are equal and are selected to optimize the collection and retention of residues 361 to the laser-textured surface 724. For example, in one embodiment, the first and second separation distances 744, 748 are selected to have a relationship to the height 742 of the knobs 740. The relationship between the separation distances 744, 748 and the height 742 of the knobs 740 is optimized to increase the surface area of the laser-textured surface 724 and to provide optimal geometries for the collection and retention of residues 361. In one version, the array 738 of knobs 740 has a ratio of the height 742 of the knob 740 to the equal first and second separation distances 744, 748 of from about 0.2:1 to about 1:1. Depending on the deposited film, the first separation distance 744 between the grooves and the groove height 733 might be relatively small, for example, on the order of 0.010″ to 0.20″, and in this case a ratio of 1:1 would be appropriate. However, grooves 728 with shallower trenches are better in controlling accumulation of polymeric etchant residues in etching chambers. In other applications, such as in PVD chambers, the width of the grooves 728 can be increased and the groove height 733 made deeper, for example, 0.10″ by 0.10″.

The knobs 740 can also have rounded edges, the degree of edge rounding being selected to increase the adhesion of residues 361 to the array 738 of knobs 740. For example, the knobs 740 can be rounded to reduce the occurrence of sharp features in the laser-textured surface 724 by increasing the radius of curvature at the rounded corners of the square projection. The degree to which the knobs 740 are rounded is achieved by adjusting the laser-texturing process used to fabricate the array 738 of knobs 740. Generally, it is desirable to avoid sharp corners to reduce accumulated film stresses when brittle deposits are formed on the textured surface, and also to assist in cleaning of soft or gummy deposits. Additionally if the surface is to be over coated with a conformal coating or if the base material is aluminum, anodization sharp corners are likely to generate coating defects or inconsistent film thicknesses In another version of cleaning and refurbishing, the process chamber 306 is cleaned by removing polymer residue including organic (carbon) and AlF₃ deposits from dielectric, quartz and metal substrate processing components. In this version, a surface of the substrate processing component having residues is contacted with a plasma stream, generated by a plasma cutter 810, sufficiently high temperature plasma stream which is scanned across the surface of the substrate processing component to burn off or vaporize the polymer residues 361 on the CVD, PVD and etch substrate processing components. The polymer residues 361 are oxidized at high temperatures with an oxygen-containing plasma stream, for example, air. The AlF₃ deposits are vaporized off using any of several types of plasma streams such as argon, nitrogen, hydrogen or helium whereas the organic deposits are vaporized off using an oxygen plasma.

In this process, the polymer residues 361 such as AlF₃ can be removed without removing relatively significant portions from the substrate processing components. For AlF₃, the plasma stream stripping is used to vaporize the film from the base material, such as the component comprising ceramic or dielectric. The plasma vaporizes the residue without vaporizing the base material, when the residue sublimes or melts at a lower temperature relative to the melting point or sublimation point of the base material. Aluminum fluoride sublimes at a temperature of 1000 to 1250° C. whereas a substrate processing component comprising aluminum oxide (Al₂O₃), quartz (SiO₂), aluminum nitride (AlN), and several other dielectric materials melt at temperatures of 1400° C. and higher. Additionally, there is poor thermal penetration of these materials due to their low thermal conductivity, making it possible to vaporize the AlF₃ residues 361 while leaving the underlying dielectric of the component unaffected by the plasma stream temperatures. Although, AlN has a relatively high thermal conductivity, it has a relatively high sublimation temperature of 2000° C., which makes it possible to vaporize the AlF₃ deposits while leaving the dielectric substrate untouched. The temperature of the process residues 361 can be controlled by setting the speed of the plasma cutter 810 passing over the process residues 361 and the type of gas used in the cutter. For example, a robotic CNC plasma cutter 810 may be traversed at a predetermined speed across the component surface to ensure removal of the residues 361 with minimal damage or heating to the underlying component surface. Typically, the temperatures of the plasma are from about 12,000° C. to less than about 20,000° C., and more typically from about 14,000 to 17000° C. These high temperatures allow the plasma stream to vaporize the AlF₃ residue while only nominally heating the surface of the underlying component.

In this process, the residues 361, which are more organic in nature, can be removed without removing relatively significant portions of the components. The process chamber 306 and the components can be ceramic, dielectric or metallic. For organic residue, an oxygen or air plasma stream is preferred as it creates an oxidizing plasma stream that can break down the carbon compounds to volatile carbon monoxide or carbon dioxide on the substrate processing components. For the organic residues, it is desirable to maintain higher speeds of the plasma cutter 810 to increase the process speed. The dielectric and ceramic components however are not oxidized by the plasma stream, thus cleaning the components without removing the base material.

This process utilizes a low cost plasma cutter 810 to create the plasma stream. The plasma cutter 810 generates a dense plasma stream by passing gas between two electrodes while energizing the field with an electric potential. This is specific to the plasma cutter 810 vendor's tool specification, such as the plasma cutter 810 manufactured by Miller Thermal Inc™. The plasma stream is typically no longer than 2 inches. A wide spread plasma stream is preferred as the temperature of the stream can be dropped to a more usable level while creating a wider application. To minimize the resonant time of the plasma stream on the part, it should be spun on a turn table so that there is little chance of accidentally melting, vaporizing and/or cracking the component. As the temperature of a plasma cutter 810 can exceed 15,000° C., the resonant time of the plasma stream on the part must be limited.

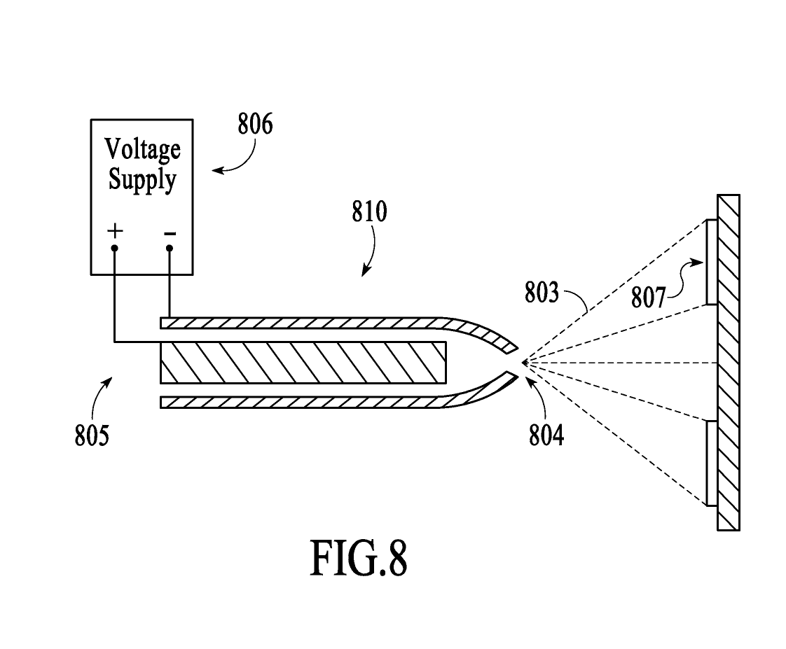

An illustrative exemplary plasma cutter 810 suitable for producing a plasma stream is schematically illustrated in FIG. 8. In this plasma cutter 810, a carrier gas is flowed between two electrodes 805, such as a cathode and anode. The cathode may be cone-shaped and the anode may be cylindrical. A voltage supply circuit 806 supplies the necessary voltage across the electrodes. A high current electric arc 804 is generated between the electrodes 805. The electric arc 804 ionizes the carrier gas, creating a high-pressure plasma stream 803, which vaporizes residues 361 807. The plasma cutter 810 may be mounted on a controllable robotic arm (not shown) to adjust the distance and angle of the plasma stream from the surface that is to be cleaned.

Having thus described illustrative embodiments of the invention, it will be apparent that various alterations, modifications and improvements will readily occur to those skilled in the art. Such obvious alterations, modifications and improvements, though not expressly described above, are nonetheless intended to be implied and are within the spirit and scope of the invention. Accordingly, the foregoing discussion is intended to be illustrative only, and not limiting; the invention is limited and defined only be the following claims and equivalents thereto.

What is claimed:

1. A method of cleaning a substrate processing component comprising a surface having a polymer coating and residues formed on the polymer coating, the method comprising:
(a) contacting the polymer coating on the surface of the substrate processing component with an organic solvent; and
(b) removing the residues with the organic solvent without removing the polymer coating.

2. A method according to claim 1 wherein the step of contacting the polymer coating on the surface of the substrate processing component with an organic solvent comprises contacting the surface with a wipe soaked with the organic solvent.

3. A method according to claim 2 comprising the step of selecting the wipe from a container prepackaged with a plurality of wipes.

4. A method according to claim 1 wherein step of contacting the polymer coating on the surface of the substrate processing component comprises spraying the organic solvent on the surface.

5. A method according to claim 4 wherein the substrate processing component surface is further wiped with a wipe soaked with the organic solvent.

6. A method according to claim 1 wherein the step of contacting the polymer coating on the surface of the substrate processing component is conducted by dipping the substrate processing component surface in the organic solvent.

7. A method according to claim 6 wherein the organic solvent is agitated by ultrasonic energy during the dipping step.

8. A method according to claim 1 wherein the polymer coating comprises a polymer sealant comprising methacrylate.

9. A method according to claim 1 wherein contacting the surface of the substrate processing component comprises contacting a substrate processing chamber wall comprising an aluminum structure coated with (i) nickel plating, (ii) anodized aluminum, (iii) silicon carbide, and (iv) a polymer coating comprising a polymer sealant.

10. A method according to claim 1 wherein the organic solvent comprises at least one of cyclohexanone, ethanol amine, ethyl acetate, 2-ethoxy ethanol amine, heptane, hydroxylamine, methyl ethyl ketone, N-methyl pyrrolidone, tetrahydrofuran and toluene.

11. A method of cleaning adhesive residues from a surface of a substrate processing component, the method comprising:
(a) contacting the adhesive residues on the surface of the substrate processing component with an organic solvent; and
(b) removing the adhesive residues with the organic solvent without eroding or otherwise damaging the substrate processing component.

12. A method according to claim 11 wherein contacting the surface of the substrate processing component is conducted by a wipe soaked with the organic solvent.

13. A method according to claim 11 wherein contacting the surface of the substrate processing component is conducted by spraying the organic solvent on the surface.

14. A method according to claim 1 wherein the organic solvent comprises at least one of cyclohexanone, ethanol amine, ethyl acetate, 2-ethoxy ethanol amine, heptane, hydroxylamine, methyl ethyl ketone, N-methyl pyrrolidone, tetrahydrofuran and toluene.

15. A method of refurbishing a substrate processing component comprising a polymer layer adhered to an underlying ceramic structure with an adhesive, the method comprising:
(a) removing the polymer layer from the ceramic structure, thereby leaving behind residual adhesive on the ceramic structure;
(b) contacting the residual adhesive with an organic solvent to remove the residual adhesive from the underlying ceramic structure; and
(c) replacing the polymer layer on the ceramic structure.

16. A method according to claim 1 wherein the organic solvent comprises at least one of cyclohexanone, ethanol amine, ethyl acetate, 2-ethoxy ethanol amine, heptane, hydroxylamine, methyl ethyl ketone, N-methyl pyrrolidone, tetrahydrofuran and toluene.

17. A method of ablating adhesive residues from a surface of a substrate processing component, the method comprising:
(a) scanning a laser beam across the surface of the substrate processing component at an energy density that is sufficiently high to ablate the adhesive residues.

18. A method according to claim 17 wherein the laser beam has a wattage of from about 9.6×10⁶ W/cm² to about 8.6×10⁷ W/cm².

19. A method according to claim 17 wherein the laser beam is a pulsed or continuous wave beam.

20. A method according to claim 17 wherein the laser is a CO₂ laser, Nd—YAG laser, Er:Nd—YAG laser, argon laser, high power diode laser or other solid state laser.

21. A method according to claim 17 wherein the laser beam has a power range from about 100 Watts to about 5000 Watts.

22. A method according to claim 17 wherein the substrate processing component comprises a polymer coating below the acrylic residues, and wherein (a) comprises ablating the polymer coating and the acrylic coating in addition to ablating the adhesive residues.

23. A method according to claim 17 wherein (a) comprises scribing features on the surface of the component in addition to ablating the adhesive residues.

24. A method according to claim 17 wherein the substrate processing component comprises a retaining ring or a gas distribution plate.

25. A method according to claim 17 wherein the method further comprises removing the adhesive residue by flowing a carrier gas across the surface of the substrate processing component.

26. A method of refurbishing a substrate processing component comprising a surface comprising adhesive residues over a polymer layer which covers an underlying metal structure, the method comprising:
(a) scanning a laser beam across the surface of the substrate processing component at an energy density level that is sufficiently high to ablate the adhesive residues; and
(b) forming a new polymer layer on the metal structure.

27. A method according to claim 26 wherein the laser beam has a wattage of from about 9.6×10⁶ W/cm² to about 8.6×10⁷ W/cm².

28. A method according to claim 26 wherein the laser beam is a pulsed or continuous wave beam.

29. A method according to claim 26 wherein the laser is a CO₂ laser, Nd—YAG laser, Er:Nd—YAG laser, argon laser, high power diode laser, or other solid state laser.

30. A method according to claim 26 wherein the laser beam has a power range from about 100 Watts to about 5000 Watts.

31. A method according to claim 26 wherein the substrate processing component comprises a polymer coating comprising an epoxy layer, and wherein (a) comprises ablating the epoxy layer in addition to the adhesive residues.

32. A method according to claim 26 wherein (a) comprises scribing the surface of the metal structure with ablation lines in addition to ablating the adhesive residues.

33. A method according to claim 26 wherein the substrate processing component comprises a retaining ring or a gas distribution plate.

34. A method according to claim 26 wherein the adhesive residues comprise an acrylic adhesive residue.

35. A method of cleaning a substrate processing component, the method comprising:
(a) contacting a surface of the substrate processing component having residues with a plasma stream; and
(b) scanning the plasma stream across the surface of the substrate processing component at a temperature that is sufficiently high to vaporize the residues.

36. A method according to claim 35 wherein the plasma stream comprises oxygen or air.

37. A method according to claim 35 wherein the plasma stream comprises argon, nitrogen or helium.

38. A method according to claim 35 wherein the plasma stream is generated by a plasma cutter.
